(19) United States
(12) Patent Application Publication
(10) Pub. No.: US 2010/0206643 A1
(43) Pub. Date: Aug. 19, 2010

(54) Input Device

(75) Inventor: Gregory Steeves, Hants (GB)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/593,332

(22) PCT Filed: Mar. 6, 2008
(86) PCT No.: PCT/EP2008/001786

§ 371 Date: May 3, 2010

(30) Foreign Application Priority Data
Mar. 26, 2007 (GB) 0705712.8

(51) Int. Cl. G06F 3/045

(52) U.S. Cl. 178/18.05

(57) ABSTRACT

A resistive input pad that can be used as a keypad and/or a touchpad comprises a top surface layer with a plurality of resistive sensing pads disposed below the top surface layer. The top surface extends continuous over the surface of the input pad. The number of resistive sensing pads does not need to match the number of keys that are distinguishable by the keypad print on the top surface layer. The grid formed by the resistive sensing pads can be more or less fine than the grid formed by the keys as defined by the keypad print. With a sufficiently fine array of resistive sensing pads the input pad can be used for navigational and drawing purposes similar to a conventional touchpad.

### FIELD OF THE INVENTION

The present invention relates to a resistive input pad such as key and/or touchpad, in particular to an input pad that can be used in electronic devices for data input.

### BACKGROUND OF THE INVENTION

Electronic devices frequently employ touchpads or keypads as a means of enabling user input to the system. Touchpads are widely implemented in notebook computer applications and often serve the function of a traditional pointing device such as a computer mouse. Some attributes of conventional touchpads make them unsuitable for the keypad of a mobile device, such as a mobile phone or a mobile media player. These touchpads typically have a capacitive sensor which is very sensitive and does not have any pressure threshold. Thus, any touch on the surface, be it at a very low contact pressure, is registered. This can be problematic for mobile devices in which the keypad can often be touched inadvertently by the user or by other objects. A specific problem is that users often keep their thumb in contact with the surface for the majority of the time and will not take their thumb from the surface during user interaction, such as input of text or numbers. This is not a problem for conventional pushbutton keys, but makes capacitive sensing touchpads unsuitable. Resistive sensing touchpads can overcome this problem by having a threshold value for the minimum pressure required for input. However, current key and/or touchpads solutions for resistive touch can only output an x,y coordinate value and this limits the inputs to only one keystroke at the time, and makes it difficult to be accurate enough for small keypads.

### DISCLOSURE OF THE INVENTION

On this background, it is an object of the present invention to provide an input pad that overcomes or at least reduces the drawbacks indicated above.

This object is achieved by providing a input pad comprising a top surface layer, and an array of resistive sensing pads disposed under the top surface layer.

Thus, an input pad construction is obtained with which several simultaneous keystrokes can be registered without any problem.

The resistive sensing pads can include a layer of conductive rubber. Conductive rubber has an inbuilt pressure threshold above which it abruptly changes to conductivity.

The resistive sensing pads can have a conductivity that is pressure dependent.

The array can form a grid.

The top surface layer can be formed by a single sheet of material.

The keypad graphics can be printed on the top surface layer.

The keypad graphics on the top surface layer are generated by backlighting.

The grid does not need to match one to one with a grid of keys in the keypad print.

One resistive sensing pad can be shared by several keys as defined by the keypad print.

The grid formed by the array of resistive sensing pads can be finer than the grid formed by the keys as defined by the keypad print.

The resistive sensing pads can be wired to a connector.

The top surface layer may allow some flexing.

The resistive sensing pads can be supported by a printed wired board.

The printed wired board can be part of a device in which the key and/or touch pad is used.

The resistive sensing pads can be linked to form a mat.

The top surface layer may extend continuous over the whole surface of the input pad.

The top surface may not allow any substantial flexing, in which case the pressure resistive pads can be disposed along the periphery of the top surface or along the periphery of an element that carries the top surface.

The top surface can be part of a cover of a mobile device, in which case the resistive sensing pads can be disposed between the periphery of the cover and the frame of the mobile device.

Further objects, features, advantages and properties of the input pad according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is a front view of a mobile device with a input pad according to an embodiment of the invention,

FIG. 2 is a front view of a input pad according to an embodiment of the invention,

FIG. 3 is a sectional view of the input pad illustrated in FIG. 2, and

FIG. 4 shows another embodiment of the input pad according to the invention in a mobile device.

### DETAILED DESCRIPTION OF PREFERRED EMBODIMENTS

In the following detailed description, the input pad according to the invention will be described by the preferred embodiments. The input pad according to the present invention can be used as a keypad and as a touchpad.

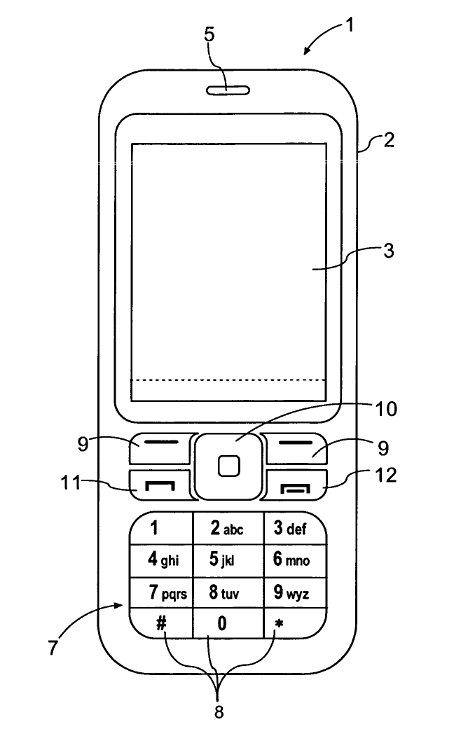

The input pad according to the invention can be used in a stationary device, such as a PC, in a portable device, such as a laptop computer or in a mobile device, such as a mobile phone. FIG. 1 illustrates a mobile phone 1 with an input pad according to an embodiment of the invention.

The mobile phone 1 comprises a user interface having a housing 2, a display 3, an on/off button (not shown), a speaker 5 (only the opening is shown), and a microphone 6 (not visible in FIG. 1). The phone 1 according to the first preferred embodiment is adapted for communication via a cellular network, such as the GSM 900/1800 MHz network, but could just as well be adapted for use with a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

The input pad 7 has a first group of keys 8 as alphanumeric keys. The input pad pad 2 has additionally a second group of keys comprising two softkeys 9, two call handling keys (offhook key 11 and onhook key 12), and a 5-way navigation key 10. In this embodiment, the first group of keys is formed by the input pad according to the invention, whilst the second group of keys is formed by conventional pushbutton keys. In another embodiment (not shown) all the keys of the keypad are formed by the input pad according to the invention. In the shown embodiment keypad graphics, including the division lines between the keys are printed on a top surface layer of the keypad.

A releasable rear cover (not shown) gives access to the SIM card (not shown), and a rechargeable battery 24 (cf. FIG. 3) in the back of the mobile phone that supplies electrical power for the electronic components of the mobile phone 1.

The mobile phone 1 has a flat display 3 that is typically made of an LCD with optional back lighting, such as a TFT matrix capable of displaying color images.

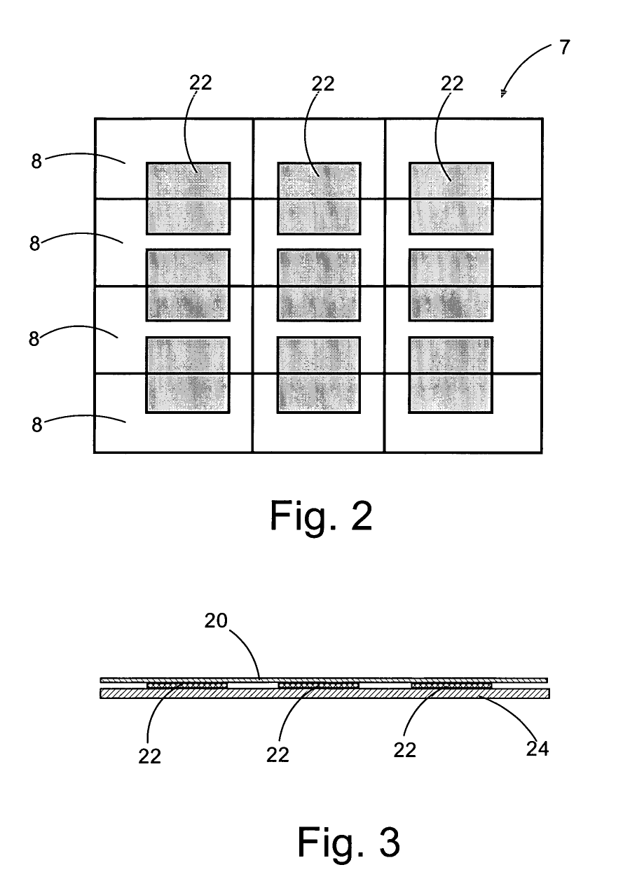

FIGS. 2 and 3 illustrate a first embodiment of the input pad 7 according to the invention. The input pad includes a top surface layer 10. The top surface layer 20 can be provided with keypad print (as illustrated in FIG. 1) and with print that divides the keys (as illustrated in FIGS. 1 and 2. The keypad print and the lines that divide the keys can be printed, engraved, embossed or projected by backlighting onto the top surface layer 20. The printed or engraved keypad print can be applied to the front or to the rear of the top surface layer. The keys 8 are arranged in the form of a grid, in this embodiment a 3 by 4 grid, as is common in the standard ITU-T keypad for telephones. However, any other number of keys can be defined in other forms of grids (not shown).

In this embodiment the top surface layer 20 is formed by a single layer of material, such as a polymer material or a mixture of polymer materials. The top surface layer 20 allows for some flexing.

A plurality of resistive sensing pads 22 are arranged in a grid shaped array under the top surface layer 20. In this embodiment the resistive sensing pads 22 are arranged in a 3 by 3 array. The pressure sensitive pads 22 each overlap to keys 8 in the present embodiment and are sufficient for covering 12 keys 8. The pressure sensitive pads include a layer of conductive rubber, with a pressure dependent resistance. Such rubber material is available from Xilor Research LLC under the trademark ZOFLEX® ZL45.1. This is a pressure sensitive conductive rubber with a shore A hardness of approximately 45. Its resistance change with pressure is very drastic: the material is at high resistance state>30MW when pressure is below the actuation pressure; the material is at very low resistance state (can be as low as 0.1W or less) when pressure is equal or above the actuation pressure. Other conductive rubbers with pressure sensitive resistance can be used.

The resistive sensing pads 22 are supported by the printed wired board 24. The printed wired board 24 does not necessarily form a part of the input pad 7, but can be part of the device in which the key and/or touch pad 7 is used, such as the mobile phone 1. The printed wired board is wired so as to detect the change in resistance of the resistive sensing pads 22 upon application of pressure on the top surface layer 20 in the area of the resistive sensing pads 22 concerned. In another embodiment (not shown) the resistive sensing pads 22 are wired to a connector. In an embodiment (not shown) the resistive sensing pads 22 are interconnected by filaments or the like to form a resistive sensing mat (not shown).

In operation, the printed wire board will be connected to a processor in the device in which the keypad is used. The processor will receive signals from each of the resistive sensing pads 22 and determine the position of touch/pressing from the combined signal from the resistive sensor pads 22. The processor will also be able to determine multiple simultaneous presses on the surface. Thus, simultaneous keystrokes can be made.

The conductive rubber in the resistive touchpad 22 has a particular switch over pressure at which the conductivity changes abruptly. Thus, the rubber material has an inbuilt threshold and if pressure is applied below this threshold, no user input is registered. This is an advantage if the user incidentally touches the input pad 7 or if the user does not completely take his/her thumb or other finger out of touch from the input pad 7 during user input.

In an embodiment (not shown) the array of resistive sensing pads 22 is significantly more fine than in the shown embodiment and significantly more fine than would be required to distinguish between presses on the various keys of the keypad. In this embodiment, a navigational signal created by a user moving a finger or other object over the input pad can be determined accurately so as to allow drawing and/or navigation input identical to input from a conventional touchpad. The minimum resolution defined by the grid of resistive sensing pads 22 will depend on the type of application. For simple navigating in menus and applications on a mobile phone a relatively low resolution will be acceptable, whereas drawing and handwriting recognition applications will require a higher resolution.

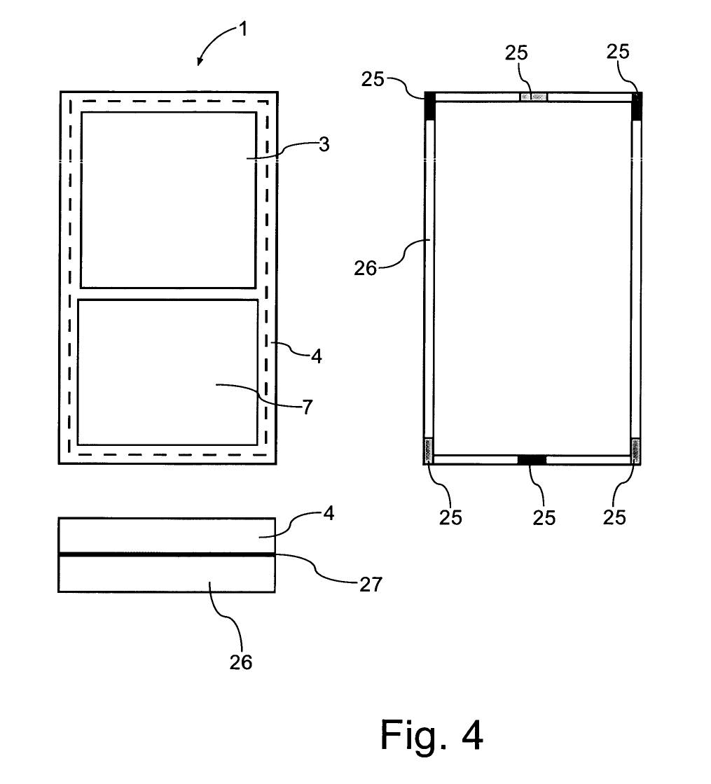

FIG. 4 illustrates another embodiment of the keypad 7 according to the invention. This embodiment is illustrated with reference to a mobile phone 1. The mobile phone is similar to the mobile phone described with reference to FIG. 1. In this embodiment the keypad 7 has a top surface that is rigid, i.e. it does not allow for any substantial flexing. The need for rigidity is the aim to avoid twisting of the cover 4, since such twisting would reduce the accuracy of the signal delivered by the resistive sensing pads 22 and will render it more difficult for the processor and the device in which the input pad 7 is used to determine the exact pressure point of the object that is touching the input pad.

The top surface is integral with the front cover 4 of the mobile phone. The front cover 4 is suspended from the core frame 26 of the mobile phone by resistive sensing pads 25 that are distributed along the periphery of the front cover 4. The resistive sensing pads 25 are disposed on the line 27 in between an upper surface of the core frame 26 and the downwardly projecting edges of the front cover 4. The resistive sensing pads 25 are coupled to a processor in the mobile phone 1.

The combined signal of the resistive sensing pads 25 allows the processor in the mobile phone 1 with the help of appropriate software routines to determine at which position on the cover pressure is applied. When the pressure applied is above a given threshold and when the position is determined by the combined signal of the resistant sensing pads 25, the processor considers the input as a keystroke for the key associated with the position at which the input pad has been touched. Continuous or regular monitoring of the signal from the resistive sensing pads 25 will also allow the processor to recognize a moving point of pressure on the front cover 4. Such a moving point of pressure can be used as navigational input. Any position on the front cover on which pressure is applied above the threshold for changing the conductivity of the pressure pads can be determined. Thus, a complete front surface of the front cover 4 can be used as a input pad, including the area of the display 3.

Similar to the embodiment above, the key print can be printed on the input pad 7. Alternatively the key print can be created by backlighting (in this case the top surface of the input pad needs to be substantially transparent).

The surface of the upper surface layer 20 can be flush or can be provided with embossed or engraved parts of keypad print and/or lines dividing the input pad 7 into keys 8.

The invention has numerous advantages. Different embodiments or implementations may yield one or more of the following advantages. It should be noted that this is not an exhaustive list and there may be other advantages which are not described herein. One advantage of the invention is that it allows for a user to support the device in which the keypad is used with the thumb or other finger on the input pad, like a user would do with a conventional pushbutton keypad, without activating any function of the keypad. Another advantage of the invention is that multiple simultaneous key presses can be registered, which is particularly advantageous in several existing software protocols, e.g. gaming. Another advantage of the present invention is that it allows for a navigational function, such as in drawing or navigating with the single input solution. Yet another advantage of the present invention is that in the production facilities the arrangement of keys can be redefined almost instantaneously. Yet another advantage of the invention is that many different types of material can be used for the top surface layer since the resistive sensor type pads do not require any specific characteristics for the top surface layer. Another advantage of the present invention is that the housing part in which the input pad is disposed can be substantially completely rigid and made of any rigid material, such as metal, molded plastic and wood. Touch or pressure on any part of the surface of the element in which the keypad is disposed can be registered through a single method.

Although the invention has been described with reference to resistive sensing pads that use conductive rubber, it should be understood that any other type of resistive sensing pads can be used as long as they measure the pressure changes accurately and consistently enough.

The term “comprising” as used in the claims does not exclude other elements or steps. The term “a” or “an” as used in the claims does not exclude a plurality.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon. Moreover, it should be appreciated that those skilled in the art, upon consideration of the present disclosure, may make modifications and/or improvements on the apparatus hereof and yet remain within the scope and spirit hereof as set forth in the following claims.

1. An input pad comprising:
a top surface layer, and
an array of resistive sensing pads disposed under the top surface layer.

2. An input pad according to claim 1, wherein said resistive sensing pads include a layer of conductive rubber.

3. An input pad according to claim 1, wherein said resistive sensing pads have a conductivity that is pressure dependent.

4. An input pad according to claim 1, wherein said array forms a grid.

5. An input pad according to claim 1, wherein said top surface layer is formed by a sheet of material.

6. An input pad according to claim 4, wherein keypad graphics are printed on said top surface layer.

7. An input pad according to claim 1, wherein keypad graphics on the top surface layer are generated by backlighting.

8. An input pad according to claim 6 wherein keypad print, grooves or embossments define the grid which is a grid of keys, and wherein said array of resistive sensing pads is not a one on one match with the grid of keys and the number of resistive sensing pads in the array is lower or higher than the number of keys.

9. An input pad according to claim 8, wherein one resistive sensing pad of the array is shared by several keys as defined by the keypad print, grooves or embossments.

10. An input pad according to claim 8, wherein the grid formed by the array of resistive sensing pads is finer than the grid formed by the keys as defined by the keypad print.

11. An input pad according to claim 1, wherein the resistive sensing pads are wired to a connector.

12. An input pad according to claim 1, wherein the top surface layer allows some flexing.

13. An input pad according to claim 12, wherein said resistive sensing pads are supported by a printed wired board.

14. An input pad according to claim 13, wherein the printed wired board is part of a device in which the key and/or touch pad is used.

15. An input pad according to claim 12, wherein the resistive sensing pads are linked to form a coherent surface.

16. An input pad according to claim 1, wherein the top surface layer extends continuous over a whole surface of the input pad.

17. An input pad according to claim 1, wherein said top surface layer is substantially non-flexible, wherein said top surface layer is part of a cover of a mobile device, and wherein said resistive sensing pads are disposed along a periphery of said cover.

18. An input pad according to claim 17, wherein said cover is suspended from a frame of the mobile device, and wherein said resistive sensing pads are disposed between the periphery of said cover and the frame of said mobile device.

19. A mobile device comprising the input pad according to claim 1.

20. A cover for a mobile device, said cover comprising the input pad according to claim 1.
